(19) United States
(12) Patent Application Publication
(10) Pub. No.: US 2007/0027597 A1
(43) Pub. Date: Feb. 1, 2007

(54) Method and device for recognising lane changing operations for a motor vehicle

(75) Inventors: Gabi Breuel, Stuttgart (DE); Ismail Dagli, Ludwigsburg (DE); Helmut Schittenhelm, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/572,812

(22) PCT Filed: Sep. 4, 2004
(86) PCT No.: PCT/EP04/09889

§ 371 Date: Oct. 11, 2006

(30) Foreign Application Priority Data
Sep. 23, 2003 (DE) 103 44 304.5
Jun. 9, 2004 (DE) 10 2004 027 983.7

(51) Int. Cl. G06F 17/10

(52) U.S. Cl. 701/41; 701/300

(57) ABSTRACT

A method and a device detect lane changing operations for a vehicle. This involves determining at least one observation variable which describes the lane changing behavior of an observed other vehicle. A lane changing variable which characterizes a lane changing intention of the other vehicle on the basis of a roadway lane assigned to the other vehicle is determined in dependence on the at least one observation variable.

### BACKGROUND AND SUMMARY OF THE INVENTION

The present invention relates to a method and a device for detecting lane changing operations for a vehicle.

The method and device according to the invention may be used, for example, to improve the longitudinal control system arranged in a vehicle known as the adaptive cruise control system.

The adaptive cruise control systems known from the prior art can in the main be classified in two groups. A first group comprises the straightforward cruise control systems, which maintain a prescribed longitudinal velocity of the vehicle even in cases where the roadway inclines, there is wind resistance and the like. A second group comprises the active cruise control systems, which use a radar sensor to control both the distance between the driver's own vehicle and a vehicle traveling in front and the relative velocity. If the active cruise control system detects a slower vehicle traveling in front, the longitudinal velocity of the driver's own vehicle is reduced by producing a suitable braking deceleration until a prescribed time interval between the driver's own vehicle and the vehicle traveling in front is maintained. Such control of the distance and the relative velocity significantly increases the driving comfort and reliably prevents premature fatigue of the driver, specifically in the case of long journeys on freeways.

However, on account of system-related limitations, conventional active cruise control systems assist the driver only to a restricted extent. The system-related limitations are caused, inter alia, by the maximum and minimum longitudinal velocity that can be prescribed on the active cruise control system or the maximum braking deceleration of the vehicle that is available in conjunction with the active cruise control system. If these system-related limitations are exceeded, the driver must completely resume the task of adaptive cruise control. This is the case in particular whenever a vehicle traveling in front is approached too quickly, a vehicle traveling in front decelerates sharply, another vehicle suddenly swerves into the roadway lane of the driver's own vehicle on account of a lane changing operation or the driver desires a longitudinal velocity which is greater or less than the maximum or minimum longitudinal velocity of the vehicle that can be prescribed on the active cruise control system.

The lane changing operations that lead to another vehicle suddenly swerving in have been found to be particularly critical in this connection, since they are only detected by the active cruise control system when the other vehicle is already substantially in the roadway lane of the driver's own vehicle.

It is therefore an object of the present invention to provide a method and a device of the type so that a lane changing operation carried out by another vehicle can be detected at an early time.

This object has been achieved according to the invention by a method and a device for detecting lane changing operations for a vehicle in which at least one observation variable which describes the lane changing behavior of an observed other vehicle is determined. This involves determining in dependence on the at least one observation variable a lane changing variable which characterizes a lane changing intention of the observed other vehicle on the basis of a roadway lane assigned to the other vehicle, so that a lane change of the other vehicle that is imminent on the basis of a predicted lane changing intention can be detected at an early time by evaluation of the lane changing variable.

The lane changing variable advantageously relates to swerving of the observed other vehicle into a roadway lane assigned to the driver's own vehicle, so that the swerving in operations of the other vehicle can be detected at an early time.

To allow definitive mathematical ascertainment of the lane changing intention of the observed other vehicle, the lane changing variable describes in particular the probability of an imminent lane change of the observed other vehicle. This involves deducing an imminent lane change of the other vehicle when it is found by evaluation of the lane changing variable that the probability is greater than a characteristic threshold value.

One of the most important features for the detection of a lane changing intention is the lateral dynamic behavior of the observed other vehicle in relation to the path followed by its roadway lane. It is accordingly of advantage if a first observation variable is a lane offset variable which describes the lateral shift of the other vehicle in relation to the center of its lane on the roadway, and/or a second observation variable is a lane offset alteration variable which describes a lateral velocity of the other vehicle in the orthogonal direction in relation to a tangent to the path followed by its roadway lane, and/or a third observation variable is a lateral offset acceleration variable which describes a maximum occurring lateral acceleration of the other vehicle on the basis of an imminent lane change.

Further important features result, on the one hand, from geometrical properties which the path followed by the roadway lane driven by the observed other vehicle has and, on the other hand, from characteristic time intervals which occur between the observed other vehicle and roadway markings which are provided on the surface of the roadway and define the path followed by the roadway lane of the other vehicle. With regard to an exact determination of the lane changing variable, a fourth observation variable may therefore be a lane curvature variable, which describes a curvature of the path followed by the roadway lane of the other vehicle, and/or a fifth observation variable may be a lane crossing time variable, which describes that period of time which is expected to elapse before a roadway marking delimiting the roadway lane of the other vehicle is crossed.

To allow particularly those lane changing operations that lead to potentially dangerous swerving of the observed other vehicle into a gap between the driver's own vehicle and the leading vehicle to be described as accurately as possible, it is of advantage if observation variables which describe the spatial and temporal behavior of the observed other vehicle in relation to the gap between the vehicles are determined. In this connection, a sixth observation variable may be a gap distance variable, which describes a distance of the other vehicle in relation to the gap between the vehicles, and/or an eighth observation variable may be a gap relative velocity variable, which describes a velocity of the other vehicle in relation to the gap between the vehicles, and/or a seventh observation variable may be a gap relative acceleration variable, which describes an acceleration of the other vehicle in relation to the gap between the vehicles.

The determination of the at least one observation variable generally takes place on the basis of observation data which are supplied by observation apparatus provided for the observation of the other vehicle. These observation data are generally subject to statistical variations, which are caused for example by physical phenomena and external disturbing influences and are manifested by more or less pronounced noise. This noise ultimately leads to a deterioration in the quality of the observation data supplied, and consequently to a corresponding variance of the at least one observation variable determined on the basis of the observation data. To allow a statement to be made concerning the reliability of the prediction of the lane changing intention of the observed other vehicle, it is therefore advantageous if a quality assessment or quality weighting of the at least one observation variable is performed in the determination of the lane changing variable by corresponding allowance being made for the associated variance.

The at least one observation variable and/or its variance can be determined particularly reliably by using a Kalman filter, which for this purpose evaluates the observation data supplied by the observation apparatus. The variance of the at least one observation variable then results from the covariance matrices on which the respective Kalman filtering is based.

If a number of observation variables and/or their variances are determined, they can be combined with one another for computationally efficient determination of the lane changing variable by way of a probabilistic network. On the basis of the inference of the probabilistic network, observation variables of low variance are given greater allowance than those of great variance, so that an implicit quality assessment or quality weighting of the determined alteration variables is carried out, ultimately leading to an optimization of the accuracy of the lane changing variable determined in dependence on the observation variables.

If an imminent lane change of the observed other vehicle is deduced by evaluation of the lane changing variable, driver-independent interventions in the vehicle's equipment provided for influencing the longitudinal and/or lateral dynamics of the driver's own vehicle can be performed in such a way that the possible eventuality of getting dangerously close to the other vehicle caused by the lane change is averted by appropriate adaptation of the longitudinal velocity and/or the traveling direction of the driver's own vehicle.

As an alternative, or in addition to the driver-independent interventions in the vehicle's equipment, an optical and/or acoustic and/or tactile indication can be output to the driver to draw the attention of the driver to the imminent lane change of the other vehicle.

The method according to the invention for detecting lane changing operations can be advantageously used in conjunction with an adaptive cruise control system arranged in the driver's own vehicle, which system may in particular be an active cruise control system, and/or a lateral control system arranged in the driver's own vehicle, for example with a lane keeping assist.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic view of the method according to the invention in the form of a probabilistic network,

FIG. 2 is a plan view of a coordinate-based representation of a lane changing operation, and

FIG. 3 is a schematic view of the device according to the invention.

### DETAILED DESCRIPTION OF THE PREFERRED EMBODIMENTS

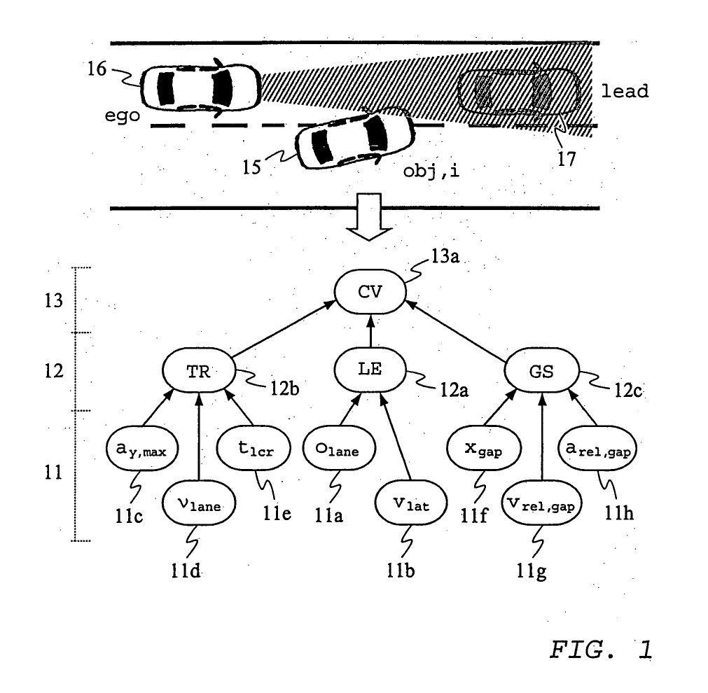

FIG. 1 schematically shows the method according to the invention for detecting lane changing operations for a vehicle, which includes different levels of a probabilistic network, a number of observation variables which describe the lane changing behavior of the observed other vehicle 15 being described on a first level 11.

Each observation variable is assigned here a specific entry node of the probabilistic network, the determination of the observation variables in the respective entry nodes taking place by using Kalman filters for object tracking and lane detection. For this purpose, the Kalman filters use state vectors of the form
\vec{x}ₗₐₙₑ=(o_{lane,ego}, ψ, c₀, c₁, wₗₐₙₑ), (1.1)
\vec{x}_{long,obj,i}=(x_{obj,i}, v_{x,ego}, a_{x,ego}, v_{x,obj,i}, a_{x,obj,i}), (1.2)
\vec{x}_{lat,obj,i}=(y_{obj,i}, v_{y,obj,i}, a_{y,obj,i}), (1.3)
where o_{lane,ego} represents a lateral shift of the driver's own vehicle 16 in relation to the center of the lane on the roadway, ψ represents the yaw angle of the driver's own vehicle 16 in relation to a tangent to the path followed by the roadway lane, c₀ represents the curvature of the roadway lane, c₁ represents the change over time of the curvature of the roadway lane, wₗₐₙₑ represents the width of the roadway lane, x_{obj,i} represents a longitudinal distance from the ith (i∈IN) observed other vehicle 15, v_{x,ego} represents a longitudinal velocity of the driver's own vehicle 16, a_{x,ego} represents a longitudinal acceleration of the driver's own vehicle 16, v_{x,obj,i} and a_{x,obj,i} represent a longitudinal velocity and a longitudinal acceleration, respectively, of the ith observed other vehicle 15, y_{obj,i} represents a lateral distance of the ith observed other vehicle 15 and v_{y,obj,i} and a_{y,obj,i} represent a lateral velocity and lateral acceleration, respectively, of the ith observed other vehicle 15.

In a first entry node 11a of the probabilistic network, a lane offset variable oₗₐₙₑ is then determined, describing a lateral shift of the ith observed other vehicle 15 in relation to the center of its lane on the roadway,
oₗₐₙₑ=y_{obj,i}+o_{lane,ego}+yₗₐₙₑ(x_{obj,i})±wₗₐₙₑ, (1.4)
it being assumed for the sake of simplicity that the width described by the variable wₗₐₙₑ is the same for all roadways. The positive or negative sign applies if the ith observed other vehicle 15 is on the left and/or right side of the driver's own vehicle 16, seen in the direction of travel.

The function yₗₐₙₑ (x_{obj,i}) entering equation (1.4) represents here the path followed by the center of the lane on the roadway of the ith observed other vehicle 15 in dependence on the distance variable x_{obj,i} and is defined as

$${y}_{lane} ( {x}_{obj , i} ) = - {x}_{obj , i} sin ( ψ ) + \frac{1}{2} {c}_{o} {x}_{obj , i}^{2} + \frac{1}{6} {c}_{1} {x}_{obj , i}^{3} . \qquad ( 1.5 )$$

On the basis of the yaw angle of the driver's own vehicle 16, the path followed by the roadway lane is turned in accordance with the value of the yaw angle ψ, allowance for which is made in equation (1.5) by an approximation term of the form
−x_{obj,i} sin (ψ) (1.6)

In a second entry node 11b of the probabilistic network, a lane offset alteration variable vₗₐₜ is also determined, describing a lateral velocity of the ith observed other vehicle 15 in a direction orthogonal to a tangent to the path followed by its roadway lane. The lane offset alteration variable vₗₐₜ then becomes
vₗₐₜ=v_{y,obj,i} cos(α)+v_{x,obj,i} sin(α), (1.7)
where the size of the angle α is obtained from the difference of the alignments of the tangent to the path followed by the roadway at distances from the driver's own vehicle 16 given by the values x=0 and x=x_{obj,i},

$$α = arctan ( \frac{ⅆ {y}_{lane}}{ⅆ x} {\vert}_{{x}_{obj}} ) . \qquad ( 1.8 )$$

To allow a model for detecting an imminent lane change to be derived from the path of the course driven by the ith observed other vehicle 15, and to allow observation variables that are characteristic of an imminent lane change to be determined, the distance variables (x_{obj,i}, y_{obj,i}) ascertained in relation to the driver's own vehicle 16 must be transformed into a system of suitable coordinates.

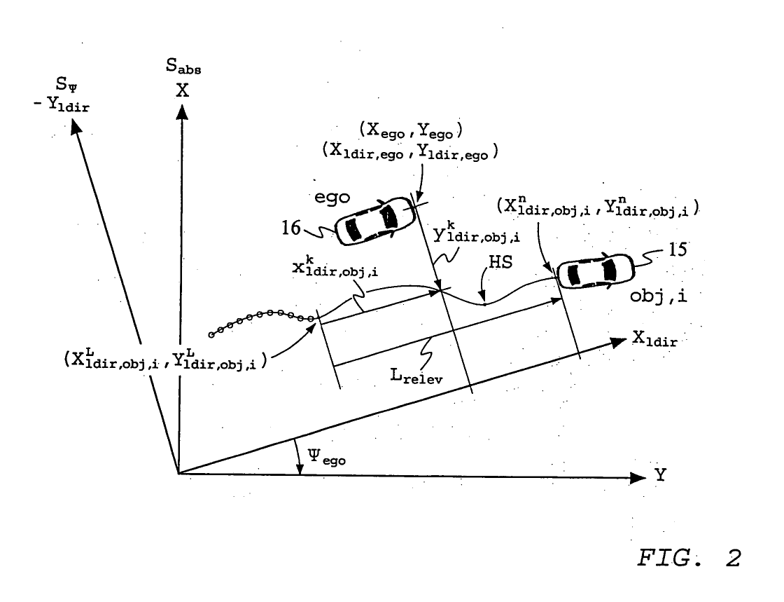

A suitable coordinate transformation is to be explained in more detail below with reference to FIG. 2. The distance variables (x_{obj,i}, y_{obj,i}) ascertained during the journey of the driver's own vehicle 16 at successive points in time of ascertainment is represented by individual measuring points o. The latter are to be used hereafter for calculating regression polynomials, from which the likely path of the course driven by the ith observed other vehicle 15 can then be derived for detecting an imminent lane change.

Since the ascertainment of the distance variables (x_{obj,i}, y_{obj,i}) takes place in relation to the driver's own vehicle 16, this forms a relative system of coordinates with respect to the ascertained distance variables (x_{obj,i}, y_{obj,i}). On the basis of the travel of the driver's own vehicle 16, however, the location and alignment of the relative system of coordinates then changes with time so as to increase the computational complexity of the detection of an imminent lane change considerably. The ascertained distance variables (x_{obj,i}, y_{obj,i}) are therefore transformed into a time-invariant absolute system of coordinates S_{abs}, the origin of which is defined by the starting point of the journey of the driver's own vehicle 16.

In the transformation of the ascertained distance variables (x_{obj,i}, y_{obj,i}), allowance is to be made for the location coordinates applicable at the respective point in time of ascertainment and the alignment ψ_{ego} of the driver's own vehicle 16,
\vec{x}_{ego}=(X_{ego}, Y_{ego}, ψ_{ego}) (1.9)

The transformation of the ascertained distance variables (x_{obj,i}, y_{obj,i}) from the relative system of coordinates into the absolute system of coordinates S_{abs} then comprises a shift by (X_{ego}, Y_{ego}) and a rotation by ψ_{ego} at the respective point in time of ascertainment. The result of this transformation is a path of the course driven by the ith observed other vehicle 15, given by a trajectory
T₁=(\vec{X}_{obj,i}, \vec{Y}_{obj,i}) (1.10)
in the absolute system of coordinates S_{abs}. The trajectory
T₂=(\vec{x}_{ldir,obj,i}, \vec{y}_{ldir,obj,i}) (1.11)
then represents the path of the course driven by the ith observed other vehicle 15 in the direction given by ψ_{ego}, that is to say in a system of coordinates S_{ψ} turned by ψ_{ego}. The location vectors \vec{x}_{ldir,obj,i} and \vec{y}_{ldir,obj,i} are determined on the basis of absolute location vectors (\vec{x}_{ldir,obj,i}, \vec{y}_{ldir,obj,i}), which for their part are obtained from the absolute location vectors (X_{obj,i}, Y_{obj,i}) of the ith observed other vehicle 15 by rotation by −ψ_{ego}. Consequently, \vec{x}_{ldir,obj,i} represents the distance covered by the ith observed other vehicle 15 in the direction of ψ_{ego}. By analogy, \vec{y}_{ldir,obj,i} represents the distance covered by the ith observed other vehicle 15 in the direction perpendicular to ψ_{ego}.

The location vectors (\vec{x}_{ldir,obj,i}, \vec{y}_{ldir,obj,i}) form the basis for determining an individual distance variable Lᵣₑₗₑᵥ relevant for an imminent lane change, which according to FIG. 2 is obtained from
x_{l,dri,obj,i}^{k}=X_{ldir,obj,i}^{k}−X_{ldir,obj,i}^{L} (1.12)
and
y_{ldir,obj,i}^{k}=Y_{ldir,obj,i}^{k}−Y_{ldir,obj,i}^{L} (1.13)

To minimize the computational complexity hereafter, a further trajectory
T₃=(\vec{x}_{ldir,obj,i}, \vec{y}_{ldir,obj,i,straight}) (1.14)
is determined, representing the trajectory T₂ on the assumption that the roadway lane follows a linear path. The distance variable \vec{y}_{ldir,obj,i,straight} here describes the lateral shift of the ith observed other vehicle 15 in relation to the center of its lane on the roadway,
y_{ldir,obj,i,straight}^{k}=y_{obk,i}^{k}+oₗₐₙₑ−yₗₐₙₑ(x_{ldir,obj,i}^{k})±wₗₐₙₑ. (1.15)

Thereafter, a probable starting point S for the lane change of the ith observed other vehicle 15 is determined. For this purpose, a regression polynomial y_{T3} is determined for the trajectory T₃, which takes place by applying the method of least squares. The probable starting point S of the lane change is then obtained at that location at which the regression polynomial y_{T3} assumes an extreme value.

Since a curvature of the path followed by the roadway lane is only of significance for the detection of a lane changing operation for the portion of roadway following the starting point S, it is sufficient if a regression polynomial y_{T2} for the trajectory T₂ is determined only for this portion of roadway, so that the computational effort in the prediction of an imminent lane change of the ith observed other vehicle 15 is reduced considerably.

In a third entry node 11c of the probabilistic network, a lateral offset acceleration variable a_{y,max} is then determined, describing the lateral acceleration of the ith observed other vehicle 15 occurring as a maximum on the basis of the imminent lane change. The determination takes place by determining a model trajectory Tₘ best fitting the trajectory T₃ and parameterized with the lateral offset acceleration variable a_{y,max}. That model trajectory Tₘ which best fits the determined trajectory T₃ then supplies the value for the lateral offset acceleration variable a_{y,max} for which allowance is to be made in the third entry node 11c. The following applies for the model trajectory:
Tₘ=(\vec{x}ₘ, \vec{y}ₘ), (1.16)
where the vectorial distance variable \vec{x}ₘ represents that part of \vec{x}_{ldir,obj,i} which lies between the probable starting point S of the lane change and the chosen prediction horizon. The variance occurring in the matching of the model trajectory Tₘ is in this case calculated as

$${σ}_{Tm} = \sqrt{\frac{1}{n - 1} {\sum }_{k = 1}^{n} {( {y}_{m}^{k} - {y}_{ldir , obj , i , straight}^{k} )}^{2}} , \qquad ( 1.17 )$$

a binary search being carried out for the model trajectory Tₘ best fitting the trajectory T₃, in which search an interval of values prescribed for the lateral offset acceleration variable a_{y,max} is successively run through, and which search ends as soon as Δσ_{Tm}=σ_{Tm}^{r}−σ_{Tm}^{r-1} in two successive search operations r−1 and r is below a given threshold ε,

$${σ}_{Tm}^{r} - {σ}_{Tm}^{r - 1} < ɛ . \qquad ( 1.18 )$$

In the fourth entry node 11d, a lane curvature variable vₗₐₙₑ is determined, describing a curvature of the path followed by the roadway lane of the ith observed other vehicle 15,

$$\begin{matrix}{v}_{lane , scal} = {τ}_{lane} {v}_{x , obj , i} , \\ with & ( 1.19 ) \\ {τ}_{lane} = ( \frac{ⅆ {y}_{T 2}}{ⅆ x} - \frac{ⅆ {y}_{lane}}{ⅆ x} ) {\vert}_{{x}_{obj}} . & ( 1.20 )\end{matrix}$$

In a fifth entry node 11e of the probabilistic network, a lane crossing time variable t_{lcr} is determined, describing that period of time which is expected to elapse before a roadway marking delimiting the roadway lane of the ith observed other vehicle 15 is crossed (known as time to line crossing). To calculate the lane crossing time variable t_{lcr}, the point of intersection between the regression polynomial y_{T2} of the trajectory T₂ and the position of the roadway marking given by

$${y}_{T 2} \pm \frac{{w}_{lane}}{2} \qquad ( 1.21 )$$

is determined,

$${y}_{T 2} - {y}_{lane} \pm \frac{{w}_{lane}}{2} {=}^{1} 0. \qquad ( 1.22 )$$

The resolution of the equation (1.22) then supplies the spatial distance at which the ith observed other vehicle 15 is expected to cross the roadway marking. To determine the lane crossing time variable t_{lcr}, it is assumed for the sake of simplicity that the velocity variable v_{x,obj,i} is constant, so that therefore

$${t}_{lcr} = \frac{{x}_{icr}}{{v}_{x , obj , i}} . \qquad ( 1.23 )$$

To allow particularly those lane changing operations that lead to potentially dangerous swerving of the ith observed other vehicle 15 into a gap between the driver's own vehicle 16 and the leading vehicle 17 to be detected, further observation variables which describe the spatial and temporal behavior of the ith observed other vehicle 15 in relation to the gap between the vehicles are determined.

Accordingly, in a sixth entry node 11f, a gap distance variable x_{gap} is determined, describing a distance of the ith observed other vehicle 15 in relation to the gap between the vehicles,

$${x}_{gap} = {x}_{obj , i} - {x}_{ego , gap} \\ mit \\ {x}_{ego , gap} = \frac{{x}_{lead}}{2} , \qquad ( 1.24 )$$

in a seventh entry node 11g, a gap relative velocity variable v_{gap,rel} is determined, describing a velocity of the ith observed other vehicle 15 in relation to the gap between the vehicles,

$${v}_{gap , re 1} = {v}_{obj , i} - {v}_{gap} \\ mit \\ {v}_{gap} = \frac{{v}_{x , ego} + {v}_{x , lead}}{2} , \qquad ( 1.25 )$$

and, in an eighth entry node 11h, a gap relative acceleration variable a_{gap,rel} is determined, describing an acceleration of the ith observed other vehicle 15 in relation to the gap between the vehicles,

$${a}_{gap , rel} = {a}_{obj , i} - {a}_{gap} \\ mit \\ {a}_{gap} = \frac{{a}_{x , ego} + {a}_{x , lead}}{2} , \qquad ( 1.26 )$$

The determination takes place by determining a theoretical gap between vehicles best fitting the gap between the vehicles and parameterized with the gap distance variable x_{gap}, the gap relative velocity variable v_{gap,rel} and the gap relative acceleration variable a_{gap,rel}. That theoretical gap between vehicles which best fits the actual gap between the vehicles then supplies the gap distance variable x_{gap}, the gap relative velocity variable v_{gap,rel} and the gap relative acceleration variable a_{gap,rel} for which allowance is to be made in the entry nodes 11f to 11h.

If there is no leading vehicle 17, x_{gap} is set to a standard value, v_{gap,rel} is set to v_{ego} and a_{gap,rel} is set to a_{ego}.

Furthermore, as a measure of quality for the observation variables determined in the entry nodes 11a to 11h, allowance is made for the associated variances. These can be derived from the covariance matrices P on which the Kalman filtering is based.

The Kalman filters for object tracking and situation detection supply the state vectors \vec{x}ₗₐₙₑ and \vec{x}_{obj,i}. In addition, the associated covariance matrices Pₗₐₙₑ and P_{obj,i} are available. Hereafter, it is assumed that the variables supplied by different Kalman filters are respectively independent of one another, so that
σ_{xq,xr}=0 (2.1)
for
x_{q}∈\vec{x}_{obj,i}, xᵣ∈\vec{x}ₗₐₙₑ. (2.2)

The calculation of the (mean) value μ_{Z} of the observation variable of the entry node Zₗ (l=a . . . h) of the probabilistic network requires functions which combine the state vectors \vec{x}ₗₐₙₑ and \vec{x}_{obj,i} of the two Kalman filters in a suitable way,
μ_{zl}=fₗ(\vec{x}_{obj,i}, \vec{x}ₗₐₙₑ). (2.3)

It is implicitly assumed by the structure of the probabilistic network that the entry nodes Zₗ are independent of one another. Consequently, it is assumed in first approximation that the variances σ_{Zl} of the observation variables of the entry nodes Zₗ have the property
σ_{Zl,Zm}=0 für l≠m (2.4)

The variance σ_{Zl} of the observation variable of the lth entry node Zₗ can be represented with the aid of a Taylor series development,
E[(Zₗ−E[Zₗ])²]=ACA^{T}, (2.5)
where C represents the covariance matrix of those variables xₛ from which the value of μ_{Zl} is determined. The matrix A comprises the derivatives at the point xₛ=μₛ,

$${A}_{s} = {[ \frac{\partial {Z}_{1}}{\partial {x}_{s}} ]}_{\overline{x} = \overline{μ}} . \qquad ( 2.6 )$$

After the determination of the variances σ_{Zl} of the observation variables of the entry nodes Zₗ, normally distributed probability density functions Nₗ(μ_{Zl}, σ_{Zl}) are set for the occupancy of the individual entry nodes Zₗ. Since the probabilistic network comprises discrete-value entry nodes Zₗ, the probability of a given interval of values [a, b] is determined according to

$${P}_{1} ( a \leq {Z}_{1} \leq b ) = {\int }_{a}^{b} \frac{ⅆ z}{{σ}_{Z 1} \sqrt{2 \prod }} \cdot exp \{ - \frac{z - {μ}_{Z 1}}{2 \cdot {σ}_{Z 1}^{2}} \} . \qquad ( 2.7 )$$

Since this integral cannot be resolved in a closed form and the carrying out of a numerical integration would be computationally inefficient, equation (2.7) is determined with the aid of a normalized distribution function of the form

$${Φ}_{1} = {\int }_{a}^{b} {N}_{1} ( {μ}_{Z 1} = 0 , {σ}_{Z 1} = 1 ) \qquad ( 2.8 )$$

so that ultimately

$${P}_{1} ( a \leq {Z}_{1} \leq b ) = {Φ}_{1} ( \frac{b - {μ}_{Z 1}}{{σ}_{Z 1}} ) - {Φ}_{1} ( \frac{a - {μ}_{Z 1}}{{σ}_{Z 1}} ) . \qquad ( 2.9 )$$

is obtained.

The inclusion of the variance σ_{Zl} of the entry nodes Zₗ makes it possible to carry out an implicit quality assessment or quality weighting of the observation variables determined in the entry nodes Zₗ, since greater allowance is made for observation variables of small variance σ_{Zl} than for those of great variance σ_{Zl} by the inference of the probabilistic network.

To establish whether or not the ith observed other vehicle 15 has swerved in, the observation variables determined on the first level 11 of the probabilistic network are grouped on a second level 12 to form intermediate variables.

In a first intermediate node 12a, the lane offset variable oₗₐₙₑ, determined in the first entry node 11a, and the lane offset alteration variable vₗₐₜ, determined in the second entry node 11b, are grouped here to form a lane offset indicating variable LE.

In a second intermediate node 12b, furthermore, the lateral offset acceleration variable a_{y,max}, determined in the third entry node 11c, the lane curvature variable Vₗₐₙₑ, determined in the fourth entry node 11d, and the lane crossing time variable t_{lcr}, determined in the fifth entry node 11e, are grouped to form a trajectory indicating variable TR. The gap distance variable x_{gap}, determined in the sixth entry node 11f, the gap relative velocity variable v_{gap,rel}, determined in the seventh entry node 11g, and the gap relative acceleration variable a_{gap,rel,} determined in the eighth entry node 11h, are finally grouped in a third intermediate node 12c to form a gap between vehicles indicating variable GS. The grouping takes place in each case in such a way that the lane offset indicating variable LE, the trajectory indicating variable TR and the gap between vehicles indicating variable GS assume the “true” state in the case of another vehicle being likely to swerve in and the “untrue” state in the case of another vehicle not swerving in.

The intermediate variables determined in the intermediate nodes 12a to 12c are then combined in an output node 13a, which forms a third level 13 of the probabilistic network, to form a common output variable in the form of a lane changing variable CV in such a way that the latter describes a swerving in probability for an imminent swerving in operation of the ith observed other vehicle 15.

The individual levels 11 to 13 of the probabilistic network accordingly form a decision hierarchy, within which the entry nodes 11a to 11h of the first level 11 describe the lane changing or swerving in behavior of the ith observed other vehicle 15, the intermediate nodes 12a to 12c of the second level 12 represent partial interim decisions, and finally the output node 13a of the third level 13 forms a final decision, taken on the basis of the interim decisions, in the form of a lane changing or swerving in intention of the ith observed other vehicle 15, characterized by the lane changing variable.

If the swerving in probability described by the lane changing variable CV is greater than a characteristic threshold value, so that imminent swerving in of the ith observed other vehicle 15 can be deduced with great certainty, driver-independent interventions take place in vehicle equipment provided for influencing the longitudinal dynamics of the vehicle 16 in such a way that the longitudinal velocity of the vehicle 16 is reduced until a prescribed safety time interval between the driver's own vehicle 16 and the swerving-in other vehicle 15 is maintained. If required, the carrying out of an automatic emergency braking operation can also be initiated to avoid running into the ith observed other vehicle 15.

The method according to the invention accordingly extends the function of active cruise control systems of a conventional type for the case of other vehicles 15 swerving in. The vehicle equipment is, for example, a braking system and/or a driving system of the driver's own vehicle 16. In this connection, it is also contemplated to perform driver-independent interventions in vehicle equipment provided for influencing the lateral dynamics of the vehicle 16 to carry out an evasive maneuver, this vehicle equipment being for example a steering system of the driver's own vehicle 16.

In addition to the driver-independent interventions in the vehicle equipment, the output of an optical and/or acoustic and/or tactile indication to the driver is instigated, drawing the attention of the driver to the imminent swerving in of the ith observed other vehicle 15.

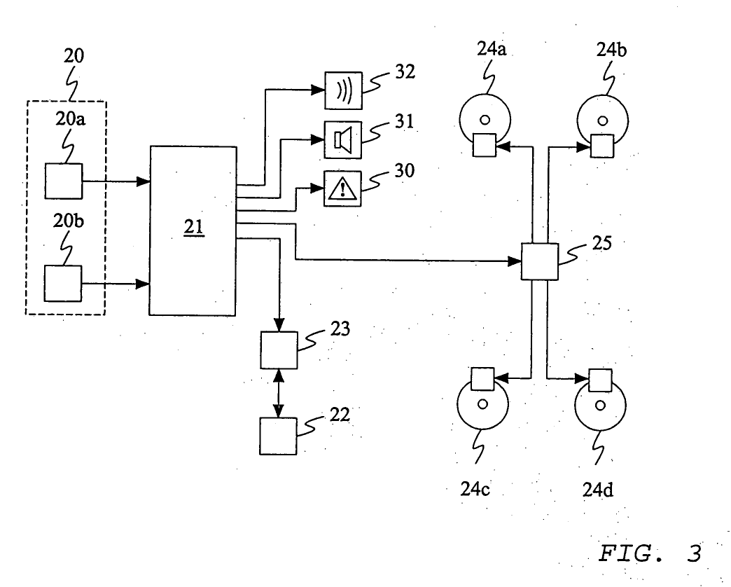

FIG. 3 shows an exemplary embodiment of a device for carrying out the method according to the invention. The device includes observation system 20 for observing another vehicle. The observation system 20 has a first sensor device 20a for object tracking to ascertain the spatial and temporal behavior of the ith observed other vehicle 15 in relation to the driver's own vehicle 16, and a second sensor device 20b for lane tracking to ascertain the spatial and temporal behavior of the ith observed other vehicle 15 in relation to the path followed by the roadway markings of the roadway lane of the driver's own vehicle 16.

The first sensor device 20a for object tracking is a radar sensor and/or a laser scanning device operating in the infrared wavelength range. The angle of coverage of the laser scanning device is typically greater than 30°, so that other vehicles located in a neighboring roadway lane can still be ascertained at a distance of 15 meters and less from the driver's own vehicle 16. To allow both the new range and the far range in front of and alongside the driver's own vehicle 16 to be reliably covered in the case where a radar sensor is used, different radar frequencies are required. For instance, a radar frequency of typically 24 GHz is used for covering the near range and a radar frequency of typically 77 GHz is used for covering the far range.

The second sensor device 20b for lane tracking is also a CCD camera or an imaging laser scanning device operating in the infrared wavelength range. As an alternative or in addition, the lane tracking takes place on the basis of electronic map data made available by a satellite-aided navigation system arranged in the driver's own vehicle 16.

The observation data supplied by the observation system 20 are subsequently fed to an evaluation unit 21, which then determines the observation variables and their variances to determine the lane changing variable CV.

To carry out the driver-independent interventions in the driving system 22 of the vehicle 16, there is a driving system controller 23, by way of which the driving torque of an engine provided as the vehicle drive can be influenced. Furthermore, to carry out the driver-independent interventions in the braking system 24a to 24d of the vehicle 16, there is a braking system controller 25, by way of which a braking torque generated in the braking system 24a to 24d can be influenced.

To output the indication to the driver, there is an optical signal transmitter 30 and/or an acoustic signal transmitter 31 and/or a tactile signal transmitter 32. The tactile signal transmitter 32 is, for example, a steering wheel torque transmitter for inducing a steering wheel torque in the form of a vibration on a steering wheel arranged in the driver's own vehicle 16. As an alternative, the tactile signal transmitter 32 may also be a structure-borne sound generator provided for generating a rumble strip noise. In this case, the two sides of the driver's own vehicle 16 may be respectively assigned separate structure-borne sound generators, so that the rumble strip noise can be generated on that side of the vehicle on which the lane changing or swerving in operation of the ith observed other vehicle 15 is imminent.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-16. (canceled)

17. A method for detecting lane changing operations for a vehicle, comprising determining at least one observation variable which describes the lane changing behavior of an observed other vehicle and determining a lane changing variable which characterizes a lane changing intention of the observed other vehicle on the basis of a roadway lane assigned to the other vehicle in dependence on the determined at least one observation variable, wherein the lane changing variable describes the probability of an imminent lane change of the other vehicle, the imminent lane change being deduced when the probability is greater than a characteristic threshold value.

18. The method as claimed in claim 17, wherein the lane changing variable relates to swerving of the other vehicle into a roadway lane assigned to the driver's own vehicle.

19. The method as claimed in claim 17, wherein a first observation variable is a lane offset variable representing a lateral shift of the other vehicle in relation to a center of the other vehicle's lane on the roadway.

20. The method as claimed in claim 17, wherein a second observation variable is a lane offset alteration variable representing a lateral velocity of the other vehicle in direction orthogonal to a tangent to the path followed by its roadway lane.

21. The method as claimed in claim 17, wherein a third observation variable is a lateral offset acceleration variable representing a maximum occurring lateral acceleration of the other vehicle based on an imminent lane change.

22. The method as claimed in claim 17, wherein a fourth observation variable is a lane curvature variable representing a curvature of the path followed by the roadway lane of the other vehicle.

23. The method as claimed in claim 17, wherein a fifth observation variable is a lane crossing time variable representing a time period which is expected to elapse before a roadway marking delimiting the roadway lane of the other vehicle is crossed.

24. The method as claimed in claim 17, wherein a sixth observation variable is at least one of a gap distance variable representing a distance of the other vehicle in relation to a gap between the vehicles located between the driver's own vehicle and a leading vehicle, a gap relative velocity variable representing a velocity of the other vehicle in relation to the gap between the vehicles, and a gap relative acceleration variable representing an acceleration of the other vehicle in relation to the gap between the vehicles.

25. The method as claimed in claim 17, further comprising making allowance for the variance of the at least one observation variable in determining the lane changing variable.

26. The method as claimed in claim 17, wherein at least one of the at least one observation variable and its variance is determined by using a Kalman filter.

27. The method as claimed in claim 17, wherein at least one of a number of observation variables and their variances are determined and combined with one another for determining the lane changing variable with a probabilistic network.

28. The method as claimed in 27, wherein at least one of the at least one observation variable and its variance is determined by using a Kalman filter.

29. The method as claimed in claim 17, wherein driver-independent interventions are performed in the driver's own vehicle's equipment provided for influencing at least one of the longitudinal and lateral dynamics of the vehicle.

30. The method as claimed in claim 17, wherein in the event of an imminent lane change, at least one of an optical, acoustic and tactile indication to the driver is output to the driver of the one vehicle.

31. The method as claimed in claim 17, wherein at least one of a longitudinal and lateral control system is arranged in the own vehicle.

32. A device for detecting lane changing operations for a vehicle, comprising an observation unit for observing another vehicle and configured for determining at least one observation variable describing lane changing behavior of the observed other vehicle, an evaluation unit configured for determining in dependence on the at least one observation variable a lane changing variable which characterizes a lane changing intention of the other vehicle on the basis of a roadway lane assigned to the other vehicle, wherein the lane changing variable describes a probability of an imminent lane change of the other vehicle, with the evaluation unit being configured to deduce an imminent lane change when the probability is greater than a characteristic threshold value.

33. The device as claimed in claim 32, wherein the observation unit comprises a first sensor device for object tracking and a second sensor device for lane tracking.
